(19) United States
(12) Patent Application Publication
(10) Pub. No.: US 2025/0297845 A1
(43) Pub. Date: Sep. 25, 2025

(54) Measuring caliper and micrometer storage stand

(71) Applicant: Michael Dean Leraas, Kernersville, NC (US)

(72) Inventor: Michael Dean Leraas, Kernersville, NC (US)

(21) Appl. No.: 18/610,554

(22) Filed: Mar. 20, 2024

(51) Int. Cl. G01B 5/00; G01B 3/18; G01B 3/20

(52) U.S. Cl. CPC G01B 5/0004; G01B 3/18; G01B 3/20

(57) ABSTRACT

This invention holds caliper and micrometer measuring tools on a flat surface, to mount vertical or horizontal, including versions holding multiple calipers, versions holding micrometers in addition to calipers. The invention is needed for tool access, protecting tool when not in use, to: have tools on display for ornamentation, display tools with personalized placard on the tools holder. The holder features an enclosed slot for the caliper jaws and slotted perch for the beam with special ‘leveling screw’ allowing use for many models, designs, sizes, and makes. The Stand captures the caliper/micrometer so it cannot fall out and is protected from damaging its important features. Elevation adjustable soft set screw is employed under the beam end, allows for leveling in the holder. The tool holder can be made from variety of suitable materials. The tool can be mounted using embedded magnets or 2 sided tape to a variety of surfaces.

### BACKGROUND OF THE INVENTION

The Measuring Caliper Storage Stand is needed to: protect sensitive measuring calipers and the precision surfaces on said instruments. The stand in needed in office and shop environments to keep caliper in good shape, keep caliper accessible, keep electronic caliper screens visible for easy verification it is turned ‘off’ and not depleting the battery. Stand variations include, but are not limited to: single caliper, 2 calipers, 1 caliper and 1 micrometer, multiple micrometers, combinations of calipers and micrometers in other configurations.

### SUMMARY OF THE INVENTION

Damaged measuring calipers and dead measuring caliper batteries led to design and manufacture of this unique and comprehensive solution. Also, not having to search for the measuring caliper (because it was in its Stand and very visible when in place) was an obvious additional benefit. Notably, this invention includes a ‘leveling screw’ on the ‘fork end’ of the part. This leveling screw is elevation adjustable to level the ‘beam’ of calipers when installed in the Stand. This is important to allow for many different styles, sizes, and makes of calipers all properly fitting in the Stand. Current design of the Stand fits 4″, 6″, and 12″ calipers of all designs. Caliper Stands of this same design are designed in a CAD program to be used for 12″ calipers also, and the design is adaptable to be scaled to other sizes as well. Micrometer Stand of same design and functionality for single/multiple micrometers of any size is related and included in the designs for this basic idea and invention.

### BRIEF DESCRIPTION OF DRAWINGS

Drawings attached to the patent file include the following views:

FIG. 1 is isometric of a single caliper stand holder.

FIG. 2 is a caliper stand holder with representative caliper installed.

FIG. 3 is caliper stand holder with hidden lines showing internal features; threaded holes, slots.

FIG. 4 is isometric of a two caliper stand holder.

FIG. 5 is a two caliper stand holder with representative calipers installed.

FIG. 6 is a two caliper stand with hidden lines showing internal features.

FIG. 7 is a micrometer AND caliper stand holder, with caliper installed.

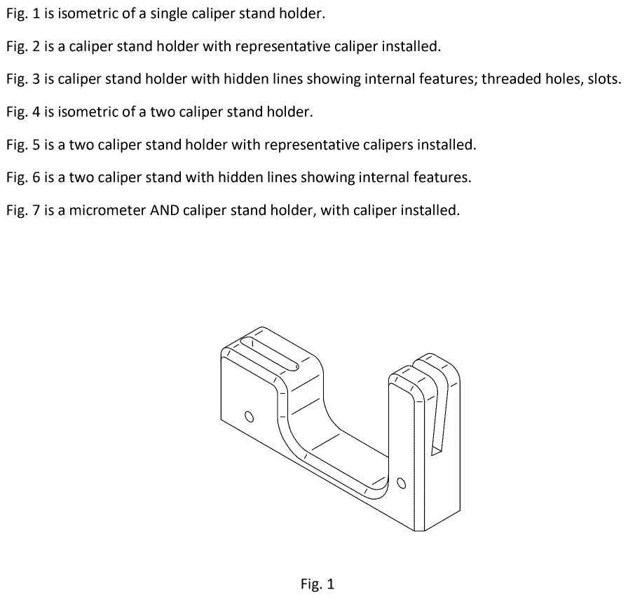

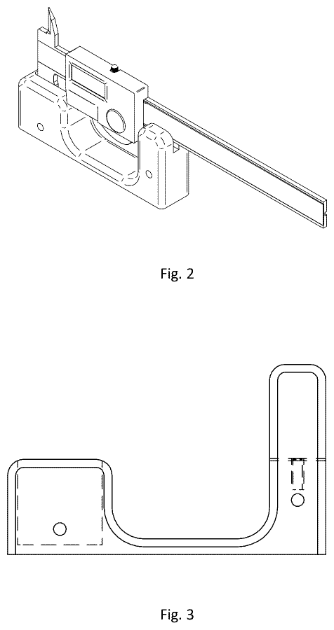

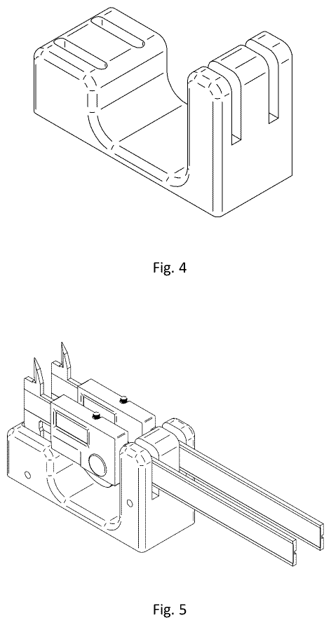

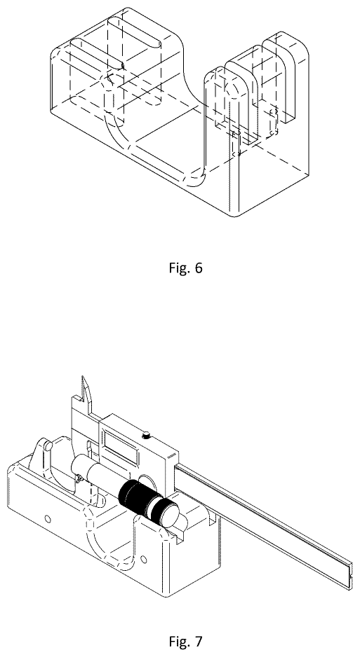

### DETAILED DESCRIPTION OF THE INVENTION

The caliper stand/caliper-micrometer stand is needed to store these measuring instruments in a safe manner and have them available for quick access. This holder protects the critical surfaces of the measuring instruments during non-use. A main feature of the stand is that it can be mounted on vertical and horizontal surfaces with 2 sided tape. Magnets embedded in the stand will also mount it to steel horizontal and vertical surfaces. The ability to mount in this manner allows mounting in a machine shop environment to the top or side of surfaces congruent to machining operations. This keep the measuring tools available and protected during the business of machining operations. Various and many configurations of this invention are included; 1 caliper, multiple calipers, and combinations of calipers and 1″ micrometers. 4″, 6″, 12″ calipers fit in this pictured sized stand. Obviously, scaling the stand would accommodate larger calipers and micrometers if desired.

1. I claim this invention uniquely stores and protects measuring calipers and micrometers while allowing easy access.

2. I claim this invention is uniquely able to be mounted to vertical as well as horizontal flat surfaces which makes it useful in shop and office environments.

3. I claim this invention uses the Leveling Screw to allow proper horizontal storage of all styles, makes, and models of calipers correctly in this universal Stand.
